(19) United States
(12) Patent Application Publication
(10) Pub. No.: US 2026/0301379 A1
(43) Pub. Date: Oct. 1, 2026

(54) DETECTION OF DISASSEMBLED ITEMS

(71) Applicant: Infosys Limited, Bangalore (IN)

(72) Inventors: Allahbaksh Mohammedali Asadullah, Hubballi (IN); Monirul Islam, Bengaluru (IN); Amirul Islam, Bengaluru (IN); Anant Pande, Bengaluru (KA)

(73) Assignee: Infosys Limited, Bangalore (IN)

(21) Appl. No.: 19/094,342

(22) Filed: Mar. 28, 2025

(30) Foreign Application Priority Data
Mar. 25, 2025 (IN) 202541028412

(51) Int. Cl. G06V 10/774; G06V 10/776; G06V 10/82; G06V 20/64

(52) U.S. Cl. CPC G06V 10/774; G06V 10/776; G06V 10/82; G06V 20/64; G06V 2201/05; G06V 2201/10

(57) ABSTRACT

Training of a detection network to detect disassembled items is disclosed. To train the detection network, three-dimensional (3D) representations are generated for known items. Material properties are assigned to each 3D representation. Each 3D representation is fragmented into various objects and imaging representations are synthesized for each fragmented object. Each imaging representation is augmented with metadata indicating the object material properties. For each augmented imaging representation, two feature vectors and a feature profile are generated for training the detection network. The two feature vectors represent two-dimensional and three-dimensional characteristics of each augmented imaging representation of an object. The detection network is trained to generate, in a feature space, embedding vectors for various imaging representations, with distances between the embedding vectors indicating the degree of association between them.

### FIELD OF THE DISCLOSURE

Various embodiments of the present disclosure relate generally to image processing. More specifically, various embodiments of the present disclosure relate to detection of disassembled items.

### BACKGROUND

In facilities with restricted access (such as airports, examination halls, or the like), security measures are essential to prevent restricted items from being carried inside. Traditionally, the detection of such restricted items has relied on manual inspection by security personnel at various checkpoints. This process typically involves visually examining individuals and searching their belongings to identify concealed items. While this may be effective in controlled environments, manual inspections are time-consuming, labor-intensive, and subject to human error, making them inefficient for large-scale facilities with high foot traffic.

In light of the foregoing, there exists a need for a technical and reliable solution that overcomes the abovementioned problems.

Limitations and disadvantages of conventional and traditional approaches will become apparent to one of skill in the art, through the comparison of described systems with some aspects of the present disclosure, as set forth in the remainder of the present disclosure and with reference to the drawings.

### SUMMARY

Methods and systems for detection of disassembled items are provided substantially as shown in, and described in connection with, at least one of the figures.

In an embodiment of the present disclosure, a system is disclosed. The system comprises processing circuitry that is configured to generate a plurality of three-dimensional (3D) representations for a plurality of items. The processing circuitry is further configured to assign a set of material properties to each of the plurality of 3D representations, fragment each 3D representation, of the plurality of 3D representations, into a plurality of objects, and synthesize a plurality of imaging representations, with a set of imaging representations being synthesized for each object fragmented from the plurality of 3D representations. Further, the processing circuitry is configured to augment each imaging representation, of the plurality of imaging representations, with metadata indicating the set of material properties of an object of the plurality of objects associated with the corresponding imaging representation, thereby generating a plurality of augmented imaging representations. The processing circuitry is further configured to train, using the plurality of augmented imaging representations, a detection network to generate, in a feature space, a first embedding vector for a first test imaging representation of a first test object. In the feature space, a distance between the first embedding vector and a second embedding vector generated for a second test object indicates a degree of association of the first test object with the second test object.

In some embodiments, the processing circuitry is further configured to execute at least one of a set of planar cuts or a set of pattern-based cuts on each 3D representation of the plurality of 3D representations to fragment the corresponding 3D representation into the plurality of objects.

In some embodiments, the processing circuitry is configured to fragment each 3D representation, of the plurality of 3D representations, into the plurality of objects using a set of constraints. The set of constraints comprises at least one of a volume of each object of the plurality of objects being greater than a volume tolerance value, a thickness of each object of the plurality of objects being greater than a thickness tolerance value, or a count of the plurality of objects being less than a threshold.

In some embodiments, each 3D representation of the plurality of 3D representations has a first identifier associated therewith. Each object of the plurality of objects has a second identifier associated therewith. The metadata augmented to each imaging representation, of the plurality of imaging representations, further indicates a link between the second identifier of the associated object and the first identifier of the 3D representation from which the associated object is fragmented.

In some embodiments, the metadata augmented to each imaging representation, of the plurality of imaging representations, further indicates a cutting technique via which the associated object is fragmented.

In some embodiments, an imaging representation, of the plurality of imaging representations, comprises at least one of a two-dimensional (2D) imaging representation and a 3D imaging representation.

In some embodiments, based on the plurality of augmented imaging representations, the processing circuitry is further configured to generate a first feature vector for each augmented imaging representation using a convolutional neural network, generate a second feature vector that represents one or more geometric properties captured from each augmented imaging representation using a computer vision model, and generate a feature profile for each augmented imaging representation based on the metadata associated with the corresponding augmented imaging representation. The detection network is trained based on the first feature vector, the second feature vector, and the feature profile.

In some embodiments, the processing circuitry is configured to train the detection network using a plurality of training batches, with each training batch comprising a set of augmented imaging representations of a set of objects. The set of objects comprises (i) at least one object fragmented from one 3D representation of the plurality of 3D representations, and (ii) another object fragmented from a different 3D representation of the plurality of 3D representations.

In some embodiments, the processing circuitry is further configured to synthesize an imaging representation for each of the plurality of 3D representations and augment the imaging representation with another metadata indicating the set of material properties of the associated 3D representation. The detection network is trained further based on the augmented imaging representation associated with each of the plurality of 3D representations.

In some embodiments, the processing circuitry is configured to train the detection network using a plurality of training batches, with each training batch comprising a set of augmented imaging representations of a set of objects. The set of objects comprises (i) at least one object fragmented from a first 3D representation of the plurality of 3D representations, and (ii) another object fragmented from a second 3D representation of the plurality of 3D representations. Each training batch, of the plurality of training batches further comprises the augmented imaging representation associated with one of the first 3D representation or the second 3D representation.

In some embodiments, when the distance between the first embedding vector and the second embedding vector is greater than an association threshold, the first test object and the second test object are not part of a same item. When the distance between the first embedding vector and the second embedding vector is less than the association threshold, the first test object and the second test object are part of the same item.

In some embodiments, the processing circuitry is further configured to evaluate the trained detection network.

In some embodiments, to evaluate the trained detection network, the processing circuitry is further configured to determine a first distance between the first embedding vector generated by the trained detection network and a third embedding vector associated with a first reference object. The first test object and the first reference object are part of one item of the plurality of items. The processing circuitry is further configured to determine a second distance between the first embedding vector generated by the trained detection network and a fourth embedding vector associated with a second reference object. The first test object and the second reference object are part of different items of the plurality of items. The processing circuitry is further configured to compare the first distance and the second distance.

In some embodiments, based on the comparison of the first distance and the second distance, the processing circuitry is further configured to assign an accuracy score to the detection network. The training of the detection network is completed based on the accuracy score being greater than a threshold.

In some embodiments, the processing circuitry is further configured to calibrate one or more hyperparameters associated with the detection network based on the evaluation of the detection network.

In some embodiments, the one or more hyperparameters include at least one of a margin for a triplet loss, a learning rate of the detection network, or a number of embedding dimensions.

In some embodiments, based on the evaluation of the detection network, the processing circuitry is further configured to generate a new 3D representation. The new 3D representation is generated for one of the plurality of items or a new item. The detection network is trained further based on the new 3D representation.

In some embodiments, prior to the training of the detection network, the processing circuitry is further configured to fragment the new 3D representation into another plurality of objects. At least one object fragmented from the new 3D representation is same as an object fragmented from one of the plurality of 3D representations.

In some embodiments, prior to the training of the detection network, the processing circuitry is further configured to fragment the new 3D representation into another plurality of objects. At least one object fragmented from the new 3D representation is different from the plurality of objects fragmented from each of the plurality of 3D representations.

In some embodiments, the system further comprises a storage element that is coupled to the processing circuitry. The processing circuitry is further configured to store the trained detection network in the storage element.

In another embodiment of the present disclosure, a method is disclosed. The method comprises generating, by processing circuitry, a plurality of three-dimensional (3D) representations for a plurality of items. The method further comprises assigning, by the processing circuitry, a set of material properties to each of the plurality of 3D representations. Further, the method comprises fragmenting, by the processing circuitry, each 3D representation, of the plurality of 3D representations, into a plurality of objects. The method further comprises synthesizing, by the processing circuitry, a plurality of imaging representations, with a set of imaging representations being synthesized for each object fragmented from the plurality of 3D representations. The method further comprises augmenting, by the processing circuitry, each imaging representation, of the plurality of imaging representations, with metadata indicating the set of material properties of an object of the plurality of objects associated with the corresponding imaging representation, thereby generating a plurality of augmented imaging representations. Further, the method comprises training, by the processing circuitry, using the plurality of augmented imaging representations, a detection network to generate, in a feature space, a first embedding vector for a first test imaging representation of a first test object. In the feature space, a distance between the first embedding vector and a second embedding vector generated for a second test object indicates a degree of association of the first test object with the second test object.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a schematic diagram that illustrates an object detection environment, consistent with disclosed embodiments of the present disclosure;

FIG. 2 is a block diagram of training processing circuitry of the object detection environment of FIG. 1, consistent with disclosed embodiments of the present disclosure;

FIG. 3 is a block diagram of implementation processing circuitry of the object detection environment of FIG. 1, consistent with disclosed embodiments of the present disclosure;

FIGS. 4A and 4B, collectively, represents a flowchart that illustrates a method for training a detection network of the object detection environment of FIG. 1, consistent with disclosed embodiments of the present disclosure;

FIGS. 5A and 5B, collectively, represents a flowchart that illustrates a method for detecting disassembled items using the trained detection network, consistent with disclosed embodiments of the present disclosure; and

FIG. 6 shows an example computing system for carrying out the methods of the present disclosure, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview

Conventionally, to provide a robust security mechanism and address the limitations of manual inspection, scanners are commonly used for scanning baggage and personal belongings. Examples of such scanners include X-ray scanners, three-dimensional (3D) scanners, milli-meter wave scanners, computed tomography (CT) scanners, or the like. These scanners generate detailed images of a bag’s contents, allowing security personnel to identify restricted items based on their shape, density, and material composition. In the context of an airport, a restricted item may be a firearm, whereas, in the context of an examination hall, a restricted item may be a mobile phone. While the scanners are capable of detecting known structures of restricted items, they have significant limitations, particularly when restricted items are disassembled and distributed within a bag or among multiple pieces of luggage. Moreover, it is even more challenging to detect such restricted items when such disassembled pieces are passed through the security over a period of time spanning, for example, days, weeks, or months. In such cases, individual components may not resemble the complete restricted item, making detection difficult.

The present disclosure addresses the above limitations by providing a system and a method that detect disassembled items. In the present disclosure, a detection network is trained for detecting disassembled items. To train the detection network, three-dimensional (3D) representations are generated for various known items. Various material properties (e.g., a density, a conductivity, a color, an acoustic property, an optical property, a texture, or the like) are assigned to each 3D representation to mimic real-world items. Further, each 3D representation is fragmented into various objects. Imaging representations are then synthesized for each fragmented object. An imaging representation may be a two-dimensional (2D) imaging representation (such as an X-ray scan), a 3D imaging representation (such as a CT scan), or a combination thereof. Each imaging representation is augmented with metadata indicating the material properties of an object associated with the corresponding imaging representation. Further, for each augmented imaging representation, two feature vectors and a feature profile are generated. The first feature vector is generated using a convolutional neural network and represents the object in the corresponding augmented imaging representation. The second feature vector represents geometric properties (e.g., surface shape, volume distribution, internal structure, or the like) of the object captured using a computer vision model. The first and second feature vectors thus represent the 2D and 3D characteristics of the object, respectively. Lastly, the feature profile is generated based on the associated metadata, and describes the features of the object.

Based on the first feature vector, the second feature vector, and the feature profile, the detection network is iteratively trained to generate, in a feature space, embedding vectors for various imaging representations. In the feature space, distances between the embedding vectors indicate the degree of association between them. The training of the detection network continues until the accuracy is greater than a predefined threshold. To improve the accuracy, 3D representations of same or new items may also be utilized.

During the detection phase, an imaging representation is obtained. In an example, the imaging representation may correspond to a bag scanned at a checkpoint of a facility. In the imaging representation, a first segment representing a first material is identified. A boundary of the first segment is refined such that the first segment with the refined boundary represents a first object. A feature profile is then generated for the first object based on the first material and the refined boundary of the first segment. The feature profile may also be generated based on volumetric information, a texture pattern, and density gradient information associated with the first object, and a spatial relationship between the first object and one or more other objects in the imaging representation. Further, the first and second feature vectors are generated for the first segment. Based on the feature profile and the first and second feature vectors and using the trained detection network, an embedding vector is generated in the feature space for the first object. Distances between the embedding vector of the first object and other embedding vectors generated for other objects in the feature space are determined, with each distance indicating a degree of association of the first object with another object.

A relevance score is then assigned to the first object based on the determined distances. If all distances are greater than an association threshold, the relevance score may be less than a threshold score. Thus, the first object may be considered not part of any restricted items, and hence, no action may be required. Conversely, if some distances are less than the association threshold, the first object may be considered to be associated with the objects that are associated with these distances. In such a scenario, a higher relevance score (e.g., greater than the threshold score) may be assigned to the first object indicating that the first object and the other associated objects may be part of a restricted item. In some scenarios, the historical detection records of associated objects, the type of bag scanned, the kind of packing associated with the first object, the time of day, one or more current events, or the like, may also be utilized for assigning (e.g., validating) the higher relevance score. Further, the threshold score may also be adjusted based on the aforementioned factors. Lastly, an alert, indicating that the first object may be part of a restricted item, may be presented on a user device of a security personnel, prompting the security personnel to take necessary actions.

The present disclosure thus provides an accurate and robust object detection technique. As the imaging representations used for training the detection network are synthetically generated, the detection network can be trained for different types of restricted items (e.g., known and not-yet-known items) and can be trained for innumerable iterations. In other words, the burden of collecting training data for the network training is significantly reduced. As a result, the detection network of the present disclosure is trained more effectively and efficiently as compared to conventional detection systems. Consequently, the detection network of the present disclosure is capable of accurately detecting disassembled items. Additionally, the utilization of other factors also strengthens the robustness of the detection technique of the present disclosure. Thus, unlike conventional systems that are limited to recognizing known shapes, the detection technique of the present disclosure enables high-accuracy detection of unknown or custom-shaped objects, even when hidden within multiple layers.

By integrating object recognition, environmental, historical, and/or current context, material analysis, and multi-layer scanning, the detection technique of the present disclosure offers a more adaptable detection solution, ensuring that restricted items, regardless of their form or concealment, are accurately detected. These advancements enhance overall safety and mitigate security risks in sensitive areas, surpassing the limitations of human-engineered detection with limited datasets. It is appreciated that the human mind is not equipped to conceptualize and engineer accurate, effective, and real-time detection of disassembled items, given the digital interconnectedness of object detection systems.

### Figure description

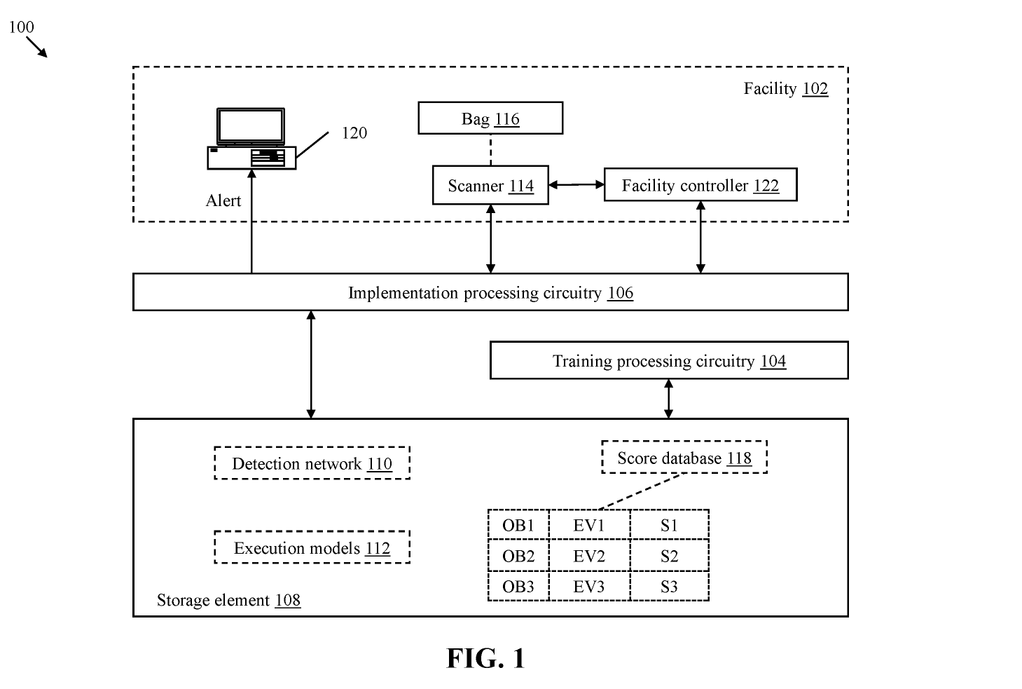

FIG. 1 is a schematic diagram that illustrates an object detection environment 100, consistent with disclosed embodiments of the present disclosure. The object detection environment 100 includes a facility 102 with restricted access. Examples of the facility 102 may include airports, train stations, examination halls, courthouses, concert venues, hospitals, malls, or the like.

In facilities with restricted access (such as the facility 102), security measures are necessary to prevent restricted items from being carried inside. Traditionally, manual inspections by security personnel have been the primary method of detecting such items. However, this approach is time-consuming, labor-intensive, and prone to human error, making it inefficient for high-traffic environments. To address these limitations, advanced scanners are widely used to generate detailed images of bag contents, enabling security personnel to identify restricted items based on shape, density, and material composition. However, while effective for detecting intact objects, these scanners struggle with disassembled components, which may not resemble the complete restricted item, making detection significantly more challenging. Moreover, if such disassembled components are passed through scanners at different times, for example, over a period of days, weeks, or months, detection of such components is even more challenging.

To overcome these challenges, a technique to detect disassembled items is disclosed in the present disclosure. To facilitate such a detection technique, the object detection environment 100 may further include training processing circuitry 104, implementation processing circuitry 106, and a storage element 108. The training processing circuitry 104, the implementation processing circuitry 106, and the storage element 108 may collectively form a detection system that may be configured to execute the detection technique of the present disclosure. The storage element 108 may correspond to a hardware storage (for example, hard drive, solid-state drive, or the like) or a cloud storage (for example, cloud services). The training processing circuitry 104 and the implementation processing circuitry 106 may be configured to execute training operations and implementation operations associated with the detection technique of the present disclosure, respectively. Although it is described that the training processing circuitry 104 and the implementation processing circuitry 106 are separate systems, the scope of the present disclosure is not limited to it. In alternate embodiments, the training processing circuitry 104 and the implementation processing circuitry 106 may be part of the same system, without deviating from the scope of the present disclosure.

### Training processing circuitry 104

The training processing circuitry 104 may be coupled to the storage element 108. The training processing circuitry 104 may include suitable logic, circuitry, interfaces, and/or code, executable by the circuitry, that may be configured to train a detection network 110. The detection network 110 may be a deep-learning model. The detection network 110 may be trained to generate an embedding vector in a feature space for each imaging representation of an object. An imaging representation may be a two-dimensional (2D) imaging representation (such as an X-ray scan), a three-dimensional (3D) imaging representation (such as a CT scan), or a combination thereof. The trained detection network 110 generates the embedding vectors in the feature space such that the embedding vectors of objects fragmented from the same item are within a predefined distance from each other (e.g., form a cluster) in the feature space. The training processing circuitry 104 may be further configured to store the trained detection network 110 in the storage element 108.

To train the detection network 110, the training processing circuitry 104 may execute various operations. For example, the training processing circuitry 104 may be configured to generate a plurality of 3D representations for a plurality of items. The training processing circuitry 104 may generate the 3D representations using at least one of execution models 112. The execution models 112 may include various artificial intelligence (AI) models that are utilized by the training processing circuitry 104 and the implementation processing circuitry 106 for the execution of the detection technique of the present disclosure. In an embodiment, the storage element 108 may be configured to store the execution models 112. For the generation of the 3D representations, the execution models 112 may include a computer-aided engineered model. In an embodiment, the computer-aided engineered model is a computer-aided design/computer-aided manufacturing (CAD/CAM) model. Each 3D representation may include various views (e.g., a top view, a bottom view, side views, an isometric view, an exploded view, a cross-sectional view, or the like) of an item. In an embodiment, the item may correspond to an intact piece (e.g., a mobile phone, a firearm, or the like), or a part of the piece (e.g., a display of a mobile phone, a battery of a mobile phone, a barrel of a firearm, a trigger of a firearm, or the like).

The training processing circuitry 104 may be further configured to assign a set of material properties to each of the plurality of 3D representations. In an embodiment, the set of material properties may include a type, a density, a conductivity, a color, an acoustic property, an optical property, a texture, or a combination thereof. For example, a 3D representation corresponding to a firearm may be assigned a material ‘Steel’. Similarly, another 3D representation corresponding to a firearm may be assigned a material ‘Aluminum’, and yet another 3D representation corresponding to a firearm may be assigned a material ‘polymer’. This assignment of material properties ensures that the 3D representations mimic the real-world objects, and hence, can enable accurate X-ray attenuation simulation.

The training processing circuitry 104 may be further configured to fragment each 3D representation into a plurality of objects. To fragment each 3D representation into the plurality of objects, the training processing circuitry 104 may be further configured to execute at least one of a set of planar cuts or a set of pattern-based cuts on the corresponding 3D representation. For the set of planar cuts, straight or angled planes may be intersected with a 3D mesh, splitting it into two or more objects. Similarly, for the set of pattern-based cuts, more complex surfaces (e.g., jigsaw-like shapes) may be used to split components into irregular pieces.

The training processing circuitry 104 may fragment each 3D representation into the plurality of objects using a set of constraints. The set of constraints may define various physical considerations with respect to the fragmentation of each object of the plurality of objects. In an embodiment, the set of constraints may include a volume of each object being greater than a volume tolerance value, a thickness of each object being greater than a thickness tolerance value, a count of the plurality of objects being less than a count threshold, or a combination thereof. In an example, the volume tolerance value may be equal to 5% of the total volume of the 3D representation, the thickness tolerance value may be equal to 2% of the total thickness of the 3D representation, and the count threshold may be equal to five. However, in other embodiments, the values may be different. To summarize, the set of constraints may define that the number of objects and volume and thickness of each object should not be such that reassembly is not feasible. For example, fragmenting a gun barrel into too many (e.g., more than five) small pieces may render reassembly impractical. Further, the set of constraints ensures that any sub-par cuts are not part of the training dataset. For example, cuts producing tiny slivers or physically impossible shards may be discarded. Similarly, an item being cut into more than five components may not be realistic, and hence, may be discarded. A robust and highly-relevant training dataset is thus generated for the training of the detection network 110.

The scope of the present disclosure is not limited to the set of constraints including volume, thickness, and count considerations. In other embodiments, various other constraints may be utilized, without deviating from the scope of the present disclosure.

The training processing circuitry 104 may be further configured to synthesize a set of imaging representations for each of the plurality of 3D representations and for each object fragmented from each 3D representation. The training processing circuitry 104 may be further configured to augment each imaging representation with metadata. For an imaging representation of a 3D representation (e.g., an item), the metadata may indicate the set of material properties of the associated 3D representation. On the other hand, for an imaging representation of an object (e.g., a disassembled piece), the metadata may indicate the set of material properties of the object associated with the corresponding imaging representation. In an embodiment, the set of material properties of the object may be similar to the set of material properties of the 3D representation from which the object is fragmented. Further, each 3D representation may have a first identifier (ID) associated therewith, whereas each object may have a second ID associated therewith. For the imaging representation of the object (e.g., a disassembled piece), the metadata may further indicate a link between the second ID of the associated object and the first ID of the 3D representation from which the associated object is fragmented. Additionally, for the imaging representation of the object (e.g., a disassembled piece), the metadata may indicate a cutting technique via which the associated object is fragmented.

The training processing circuitry 104 may thus generate augmented imaging representations from the imaging representations synthesized for the 3D representations and the plurality of objects fragmented from each 3D representation. The augmented imaging representations may mimic real-world scans obtained from the scanners utilized at various facilities.

The training processing circuitry 104 may be further configured to generate a first feature vector for each augmented imaging representation using at least one of execution models 112. For the generation of the first feature vector, the execution models 112 may include a convolutional neural network (CNN) (e.g., Residual network (ResNet)). The first feature vector may thus be a vector representation of the 2D characteristics of an object. The training processing circuitry 104 may be further configured to generate a second feature vector that represents one or more geometric properties captured from each augmented imaging representation. The one or more geometric properties may be captured using one of the execution models 112. For the generation of the second feature vector, the execution models 112 may include a computer vision model (e.g., PointNet Plus Plus (PointNet++), voxel-based 3D CNN, a mesh-based deep-learning model, or the like). In an embodiment, the one or more geometric properties may include surface shape, volume distribution, internal structure, or the like. The second feature vector may thus be a vector representation of the 3D characteristics of an object. The training processing circuitry 104 may be further configured to generate a feature profile for each augmented imaging representation based on the metadata associated with the corresponding augmented imaging representation. The feature profile may indicate the set of material properties of the object and the linking of the object to the original item.

Based on the first feature vector, the second feature vector, and the feature profile generated for an augmented imaging representation, the training processing circuitry 104 may be further configured to generate, using the detection network 110, a training embedding vector in the feature space representing the object associated with the corresponding augmented imaging representation. The detection network 110 may then be iteratively trained based on the first feature vector, the second feature vector, and the feature profile generated for various other augmented imaging representations. In other words, the training processing circuitry 104 may be further configured to train the detection network 110 using the augmented imaging representations. The detection network 110 may thus be trained based on the first feature vector, the second feature vector, and the feature profile generated for each augmented imaging representation.

The detection network 110 is trained such that post the training, the detection network 110 may be utilized to generate, in the feature space, a first embedding vector for a first test imaging representation of a first test object. In the feature space, a distance between the first embedding vector and a second embedding vector generated for a second test object indicates a degree of association of the first test object with the second test object. For example, when the distance between the first embedding vector and the second embedding vector is greater than an association threshold, the first test object and the second test object are not part of a same item. Conversely, when the distance between the first embedding vector and the second embedding vector is less than the association threshold, the first test object and the second test object may be part of the same item. In an embodiment, the distance may correspond to a Euclidean distance. In such a scenario, the association threshold may be equal to 0.5. However, in other embodiments, the values of the association threshold may be different.

The scope of the present disclosure is not limited to the distance corresponding to Euclidean distance. In several embodiments, the distance may correspond to cosine similarity. In such cases, the association threshold may be equal to 0.8, and when the distance between the first embedding vector and the second embedding vector is greater than 0.8, the first test object and the second test object are considered part of a same item. However, in other embodiments, the values of the association threshold may be different.

The training processing circuitry 104 may train the detection network 110 using various training batches. Each training batch may include a set of augmented imaging representations of a set of objects. In an embodiment, the set of objects may include at least one object fragmented from a first 3D representation and another object fragmented from a second 3D representation. Each training batch may further include the augmented imaging representation associated with one of the first 3D representation or the second 3D representation. Such construction of training batches ensures that the detection network 110 is trained robustly with an anchor item (e.g., a known item), positive examples (e.g., fragmented pieces from the same item), and negative examples (e.g., parts from different items). The straightforward, intact parts preserve baseline recognition capabilities, whereas the mixing of partial, highly modified, or jigsaw-chopped components ensures robust training coverage.

The training processing circuitry 104 may thus use a similarity or embedding approach, instead of a straightforward classifier, to learn a feature space where components belonging to the same original assembly are clustered together even if they have been custom-chopped. The detection network 110 may typically use contrastive or triplet loss which ensures objects from the same item are closer in the feature space, while objects from different items are pushed further apart. In an embodiment, common optimizers, such as adaptive moment estimation (ADAM) or stochastic gradient descent (SGD) with momentum, may be utilized to optimize the learning of the detection network 110. Such optimizers may have a learning rate schedule that decays over time.

The advantage of a similarity-based approach is that once trained, the detection network 110 can detect novel objects. For example, if an unknown object belongs to an item, the trained detection network 110 can be utilized to embed the unknown object within the neighborhood of an existing item’s embedding cluster, even if that exact cut is not part of the training dataset of the detection network 110. In such cases, the distance in the feature space serves as a measure of “how likely” an object belongs to a specific item.

The training processing circuitry 104 may be further configured to evaluate the trained detection network 110. The trained detection network 110 may be evaluated using objects that are not part of the training dataset. To evaluate the trained detection network 110, the training processing circuitry 104 may execute various operations. For example, the training processing circuitry 104 may be further configured to determine a first distance between the first embedding vector generated by the trained detection network 110 and a third embedding vector associated with a first reference object. The first test object and the first reference object may be part of one item of the plurality of items. Further, the training processing circuitry 104 may be configured to determine a second distance between the first embedding vector and a fourth embedding vector associated with a second reference object. The first test object and the second reference object may be part of different items of the plurality of items. The training processing circuitry 104 may be further configured to compare the first distance and the second distance.

Based on the comparison of the first distance and the second distance, the training processing circuitry 104 may be further configured to assign an accuracy score to the detection network 110. The accuracy score is higher if the first distance is less than the association threshold and the second distance is greater than the association threshold (e.g., embedding vectors of same items are close to each other and embedding vectors of different items are spaced apart). The aforementioned operations may be executed for varying material properties or morphological details. Highly complex or borderline shapes may be utilized to ensure real-world resilience.

The training of the detection network 110 is completed based on the accuracy score for various reference objects being greater than an accuracy threshold. In an embodiment, the accuracy threshold may be equal to 0.9 (e.g., 90%). However, in other embodiments, the value of the accuracy threshold may be different.

If the accuracy score of the detection network 110 is less than the accuracy threshold, the training processing circuitry 104 may be further configured to calibrate one or more hyperparameters associated with the detection network 110. Thus, the one or more hyperparameters associated with the detection network 110 are calibrated based on the evaluation of the detection network 110. The one or more hyperparameters may include at least one of a margin for a triplet loss, a learning rate of the detection network 110, or a number of embedding dimensions. Additionally, if the accuracy score of the detection network 110 is less than the accuracy threshold, the training processing circuitry 104 may be further configured to train the detection network 110 using new 3D representations until the accuracy score is greater than the accuracy threshold.

As the training dataset is synthesized, the training of the detection network 110 may be tailored to the detection of specific items or disassembly. For example, if the detection network 110 has lower accuracy in detecting a specific item or disassembly, based on the evaluation of the detection network 110, the training processing circuitry 104 may be further configured to generate a new 3D representation for the specific item or disassembly, with the detection network 110 being trained further based on the new 3D representation.

The present disclosure thus describes adaptive learning techniques such as dynamic adjustment of hyperparameters and utilization of new 3D representations for the specific item or disassembly for which the detection network 110 has lower accuracy for training the detection network 110.

The synthesized training dataset also allows the training of the detection network 110 for new items. For example, based on the evaluation of the detection network 110, the training processing circuitry 104 may be further configured to generate a new 3D representation for a new item, with the detection network 110 being trained further based on the new 3D representation.

In an embodiment, prior to the training of the detection network 110, the training processing circuitry 104 may be further configured to fragment the new 3D representation into another plurality of objects, with at least one object fragmented from the new 3D representation being same as an object representing specific item or disassembly (e.g., an object fragmented from one of the initial 3D representations). In another embodiment, prior to the training of the detection network 110, the training processing circuitry 104 may be further configured to fragment the new 3D representation into another plurality of objects, with at least one object fragmented from the new 3D representation being different from the plurality of objects fragmented from each of the initial 3D representations.

In an example, the detection network 110 may be trained to detect disassembled objects of firearm components. In such a scenario, the training processing circuitry 104 may generate various 3D representations of barrels, springs, triggers, and various other components of a firearm. Further, a set of material properties (e.g., material type and density) is assigned to each 3D representation. Each 3D representation of a firearm component is then fragmented into various novel cuts (e.g., objects). The objects may be in adherence with the set of constraints defined for the training of the detection network 110. Further, various 2D and 3D imaging representations may be synthesized for each 3D representation as well as for each object fragmented from each 3D representation. Each imaging representation may also be augmented with metadata indicating the material properties, the link with the original item, the cutting technique, or the like. The augmented imaging representations may thus mimic real-world scans obtained from the scanners utilized at various facilities. Further, various feature vectors and feature profiles may be generated to represent the 2D, 3D, and other features of the object and these feature vectors and feature profiles are utilized to train the detection network 110. Such training, that uses a similarity or embedding approach, provides an effective solution to the detection of novel cuts. The detection network 110 may be iteratively trained using 3D representations of different types of firearm components until the accuracy score is greater than the accuracy threshold. Throughout these iterations, the synthesized data grows in both volume and variety, ensuring that the detection network 110 parses through a broad range of possible manipulations. Each iteration may push the detection network 110 to generalize more effectively, increasing the odds of successful real-world detection.

The trained detection network 110 can be implemented for detecting various disassembled items inside the facility 102. The facility 102 may include a scanner 114. Examples of the scanner 114 may include X-ray scanners, 3D scanners, milli-meter wave scanners, CT scanners, or the like. A user (not shown) carrying a bag 116 may be required to pass the bag 116 through the scanner 114 to enter or access the facility 102. The term ‘bag’ may refer to any container or holder designed to store, carry, or protect items. This includes, but is not limited to, pouches, sacks, backpacks, totes, and other similar receptacles. The primary function of the bag 116 is to contain and secure disassembled items or pieces while passing such items through the scanner 114. The scanner 114 may be configured to scan the bag 116 and generate imaging data indicative of the bag 116.

### Implementation processing circuitry 106

The implementation processing circuitry 106 may be coupled to the storage element 108 and the scanner 114. The implementation processing circuitry 106 may include suitable logic, circuitry, interfaces, and/or code, executable by the circuitry, that may be configured to execute the detection technique of the present disclosure using the detection network 110. The implementation processing circuitry 106 may correspond to a cloud computing device, a hybrid computing device, or an edge computing device. Although the implementation processing circuitry 106 is illustrated to be external to the facility 102, the scope of the present disclosure is not limited to it. In several embodiments, the implementation processing circuitry 106 may be deployed inside the facility 102, without deviating from the scope of the present disclosure.

The implementation processing circuitry 106 may be configured to receive the raw imaging data from the scanner 114. The raw imaging data may include 2D X-ray images (e.g., multi-energy or dual-energy X-ray images) and/or 3D CT volumetric data. The implementation processing circuitry 106 may be further configured to execute one or more pre-processing operations on the raw imaging data to obtain an imaging representation of the bag 116. The one or more pre-processing operations may correspond to at least one of a noise reduction operation, an image filtering operation, a calibration operation, or a normalization operation. The image filtering operation may be executed using Gaussian or median filters. The imaging representation of the bag 116 is hereinafter referred to as the “bag imaging representation”. The bag imaging representation may include a 2D imaging representation, a 3D imaging representation, or a combination thereof.

The implementation processing circuitry 106 may be further configured to identify, in the bag imaging representation, various segments representing various materials. For example, the implementation processing circuitry 106 may be further configured to identify, in the bag imaging representation, a first segment representing a first material. The first material may have a type, a density, a conductivity, a color, an acoustic property, an optical property, a texture, or a combination thereof. In an embodiment, the implementation processing circuitry 106 may be further configured to generate an energy attenuation profile for the bag imaging representation, and the first segment is identified in the bag imaging representation based on the energy attenuation profile. In another embodiment, the implementation processing circuitry 106 may be further configured to generate at least one of a voxel density profile or a morphological profile for the bag imaging representation, and the first segment is identified in the bag imaging representation based on at least one of the voxel density profile or the morphological profile. In some embodiments, the implementation processing circuitry 106 may be further configured to label the first segment with a material ID or category.

The implementation processing circuitry 106 may be further configured to refine a boundary of the first segment such that the first segment with the refined boundary represents a first object. The implementation processing circuitry 106 may refine the boundary of the first segment using at least one of the execution models 112. In such a scenario, the execution models 112 may include a computer vision model or a segmentation model. In some embodiments, adaptive thresholding or region-growing algorithms may also be utilized to identify continuous shapes. To refine the boundary of the first segment, the implementation processing circuitry 106 may be further configured to execute various morphological operations (e.g., erosion, dilation, or the like), surface detection operations, or connectivity check operations.

The implementation processing circuitry 106 may be further configured to generate a feature profile for the first object based on the first material and the refined boundary of the first segment. In an embodiment, the feature profile may include the average and variance of material density of the first object, the perimeter of the first object, the 2D area of the first object, the surface area of the first object, and the 3D volume of the first object.

The feature profile may be generated further based on volumetric information associated with the first object. The feature profile may thus include total volume, center of mass, and simple geometric descriptors of the first object calculated using multi-view reconstruction or direct CT volumetric data. The feature profile may be generated further based on a texture pattern associated with the first object. For 2D images, Gabor filters may be utilized to detect the texture pattern (e.g., ridges, striations, or the like), whereas for 3D images, surface curvature or roughness can be estimated. The feature profile may be generated further based on density gradient information associated with the first object. The density gradient analysis highlights abrupt changes in density within or at the edges of the first object. The feature profile may be generated further based on a spatial relationship between the first object and one or more other objects in the bag imaging representation. The feature profile may thus represent how each object is positioned or oriented relative to others. This may indicate if multiple smaller parts are arranged in a way indicative of a restricted item.

The implementation processing circuitry 106 may be further configured to generate a first feature vector for the first segment using a CNN and generate a second feature vector that represents one or more geometric properties captured from the first segment in a similar manner as described above for the training processing circuitry 104.

The implementation processing circuitry 106 may be further configured to generate, using the detection network 110, in the feature space, an embedding vector for the first object based on the feature profile, the first feature vector, and the second feature vector associated with the first object. The detection network 110 trained based on imaging representations synthesized for various fragments of various items may be utilized for generating the embedding vector for the first object. The contrastive/triplet loss training of the detection network 110 ensures that objects belonging to the same item cluster together, while unrelated objects remain far in the feature space.

The feature space may also include a plurality of embedding vectors representing a plurality of other objects. In the feature space, the implementation processing circuitry 106 may be further configured to determine a plurality of distances between the embedding vector generated for the first object and the plurality of embedding vectors. Each of the plurality of distances is indicative of a degree of association of the first object with a corresponding object. A distance may correspond to cosine similarity, a Euclidean distance, or the like.

The implementation processing circuitry 106 may be further configured to compare the plurality of distances with the association threshold. The implementation processing circuitry 106 may be further configured to determine whether at least one of the plurality of distances is less than the association threshold. The implementation processing circuitry 106 may be further configured to assign a relevance score to the first object based on the plurality of distances (e.g., comparison of the plurality of distances with the association threshold). Further, the implementation processing circuitry 106 may be configured to compare the assigned relevance score with a threshold score. In an example, the threshold score may be equal to 0.6. However, in other embodiments, the threshold score may be different. The comparison of the assigned relevance score with the threshold score indicates whether the first object is part of a restricted item.

In one example, each of the plurality of distances may be greater than the association threshold. Based on each of the plurality of distances being greater than the association threshold, the relevance score assigned to the first object may be less than the threshold score. The relevance score being less than the threshold score indicates that the first object is not part of the restricted item. In such a scenario, no further action may be taken.

In another example, some of the plurality of distances may be less than the association threshold. In such a scenario, the implementation processing circuitry 106 may be further configured to identify, from the plurality of distances, a set of distances that is less than the association threshold. The set of distances may be between the embedding vector generated for the first object and a set of embedding vectors, of the plurality of embedding vectors, generated for a set of objects. Based on the set of distances being less than the association threshold, the implementation processing circuitry 106 may be further configured to determine that the first object is associated with the set of objects. Based on the first object being associated with the set of objects, the relevance score assigned to the first object is greater than the threshold score. The relevance score being greater than the threshold score indicates that the first object and the set of objects may be part of the restricted item.

The implementation processing circuitry 106 may be further configured to generate a mapping between the first object, the embedding vector generated for the first object, and the relevance score assigned to the first object, and store the mapping in the storage element 108. The storage element 108 may store the mapping in a score database 118. The score database 118 may thus store the mappings between various objects, embedding vectors generated for the objects, and the relevance score assigned to the objects. As illustrated in FIG. 1, the score database 118 may store the mapping between the first object (denoted as “OB1”), the embedding vector generated for the first object (denoted as “EV1”), and the relevance score assigned to the first object (denoted as “S1”). The score database 118 may similarly store mappings for two other objects (denoted as “OB2” and “OB3”), embedding vectors generated for these objects (denoted as “EV2” and “EV3”), and relevance scores assigned to these objects (denoted as “S2” and “S3”).

In the aforementioned scenario, as the first object is considered to be part of the restricted item, the implementation processing circuitry 106 may be further configured to generate an alert based on the relevance score being greater than the threshold score. The implementation processing circuitry 106 may be further coupled to a user device 120 of the facility 102. The user device 120 may correspond to a cellphone, a laptop, a tablet, a phablet, a desktop, a computer, or the like. The user device 120 may be associated with a security personnel (not shown). The implementation processing circuitry 106 may be further configured to present the alert on the user device 120. The alert may prompt the security personnel to check the bag 116.

Other segments present in the bag imaging representation may be detected in a similar manner as described above. Further, although not shown, the facility 102 may include various other scanners, apart from the scanner 114, and the imaging data from each such scanner may be processed in a similar manner as described above to detect disassembled items. The trained detection network 110 may thus be utilized to detect disassembled items in the facility 102.

In an embodiment, based on the checking of the bag 116, the security personnel may indicate whether the bag 116 carried a restricted item or not. This input may be provided via the user device 120. The implementation processing circuitry 106 may be further configured to refine the threshold score based on the input from the security personnel. For example, the threshold score may be maintained if the bag 116 carried a restricted item, and may be increased if the bag 116 was not carrying a restricted item.

In the description of FIG. 1, the threshold score may be set based on historical performance and known risk levels. Further, historical adjustments may update the threshold score over time using system logs and false alarm rates. The scope of the present disclosure is, however, not limited to it. In other embodiments, the threshold score may be dynamic and a function of various factors.

In an embodiment, the threshold score may be a function of one or more historical outputs generated using the detection network 110. In an embodiment, the implementation processing circuitry 106 may be associated with a memory (not shown) that may be configured to store the one or more historical outputs. In other words, the threshold score is adjusted based on past detection patterns. The past detection patterns may be analyzed for the entire facility 102 or for specific individuals, bags, or scanners. The dynamic adjustment of the threshold score ensures that if the same bag or user has been scanned multiple times, such a suspicious pattern can be flagged to the security personnel for further scrutiny.

In another embodiment, the threshold score may be a function of environmental information indicative of a physical environment associated with the first object (e.g., a physical environment associated with the scanner 114, the bag 116, or the facility 102). In an embodiment, the environmental information may include the type and size of the bag 116. For example, the threshold score may be lower for certain bag types (e.g., carry-on luggage). The threshold score being lower is indicative of the threshold score being lower than the default threshold score for regular scenarios. In another embodiment, the environmental information may include a type of packing associated with the first object. For example, the threshold score may be lower for unusual packing arrangements, such as complex layering or deliberate concealment behind other dense objects. In yet another embodiment, the environmental information may include the day and timing associated with the detection. For example, the threshold score may be lower for peak hours, national holidays, special events, or the like. In yet another embodiment, the environmental information may include the type and location of the scanner 114. For example, the threshold score may be lower for scanners placed near high-security regions or for CT scanners. In yet another embodiment, the environmental information may include seasonal characteristics associated with the facility 102. For example, the threshold score may be lower for high foot-traffic seasons.

In yet another embodiment, the threshold score may be a function of one or more current real-world events. Examples of such events may correspond to a real-world conflict, a presidential visit, or the like. In such cases, the threshold score may be lower.

In the description of FIG. 1, the relevance score is assigned to any object based on distances between the embedding vectors. The scope of the present disclosure is, however, not limited to it. In other embodiments, various scenarios may be considered for assigning relevance scores to objects, without deviating from the scope of the present disclosure.

In an embodiment, the implementation processing circuitry 106 may assign the relevance score to the first object based on temporal information associated with detection of the set of objects. In an embodiment, the temporal information may be stored in the memory associated with the implementation processing circuitry 106. The temporal information associated with detection of the set of objects indicates whether similar or associated components are detected in close temporal proximity. Thus, repeated or correlated detections can be utilized to enhance the detection technique of the present disclosure. The implementation processing circuitry 106 may implement a decay function that increases threat severity when similar or associated components appear in close temporal proximity. The time between correlated detections and a decay constant may be utilized to assign the relevance score. This ensures that multiple suspicious objects detected within a short time window amplify each other’s relevance scores.

In another embodiment, the implementation processing circuitry 106 assigns the relevance score to the first object based on a type of the first material, the environmental information indicative of the physical environment associated with the first object, and historical data associated with the physical environment. In some embodiments, the relevance score may also be a function of the one or more current real-world events. The historical data associated with the physical environment may include historical information associated with bags, scanners, checkpoints of the facility 102, or the like. In an embodiment, the implementation processing circuitry 106 may be further configured to assign a weight to each of the type of the first material, the environmental information, and the historical data. The relevance score is thus assigned to the first object further based on the type of the first material, the weight assigned to the type of the first material, the environmental information, the weight assigned to the environmental information, the historical data, and the weight assigned to the historical data. In an embodiment, the implementation processing circuitry 106 may utilize an AI algorithm to merge the embedding vector distances and the aforementioned factors/scenarios.

The weight assigned to each of the type of the first material, the environmental information, and the historical data may be dynamic. For example, certain materials known to be commonly used in restricted items are assigned higher weights. In other words, high-density metals (e.g., steel alloys) commonly used in firearms are assigned higher weights than benign materials (e.g., plastics, clothes, or the like). Similarly, for high-traffic periods, scanners being located at critical checkpoints, the weight assigned to the environmental information may be increased. Similarly, if there is a suspicious history associated with the same/similar bag appearing at repeated intervals or multiple checkpoints within a short time, the historical data associated with the physical environment is assigned a higher weight. Further, in an embodiment, based on the input received from the security personnel based on the checking of the bag 116, the implementation processing circuitry 106 may be configured to refine the weights. Additionally, in some embodiments, the weight assigned to the type of the first material may be higher than the weight assigned to the environmental information, and the weight assigned to the environmental information may be higher than the weight assigned to the historical data.

The facility 102 may have a facility controller 122 associated therewith. The facility controller 122 may be coupled to the implementation processing circuitry 106. The facility controller 122 may include suitable logic, circuitry, interfaces, and/or code, executable by the circuitry, that may be configured to perform various operations. For example, the facility controller 122 may be configured to obtain the environmental information and the historical data, and provide the environmental information and the historical data to the implementation processing circuitry 106. Further, the facility controller 122 may be configured to obtain information associated with the one or more current real-world events from various governmental or news sources, and provide the information associated with the one or more current real-world events to the implementation processing circuitry 106.

In an example, the bag imaging representation of the bag 116 may indicate various segments. The boundary of each segment may be refined to obtain various object candidates. For each object, the feature profile, the first feature vector, and the second feature vector are generated, which act as an input to the detection network 110. The output of the detection network 110 is the embedding of the object in the feature space with embedding vectors of objects fragmented from same items forming a cluster. This association information can be utilized to determine whether an object is part of a restricted item. Additionally, factors such as the material of the object, the day and time the bag 116 was scanned, current events, location and type of the scanner 114, historical detections, or the like, may be utilized to enhance the determination of whether any object is part of a restricted item. The self-sufficient training of the detection network 110 ensures that any item (e.g., a gun) with not-so-ordinary material/metal can be detected accurately.

In the present disclosure, the implementation processing circuitry 106 may thus integrate multidimensional similarity (e.g., geometric, material, contextual), temporal decay functions, and an adaptive threshold mechanism in a unified framework. This synergy significantly increases robustness for detection of disassembled items and ensures continuous adaptability to evolving threat landscapes.

The scope of the present disclosure is not limited to the relevance score assignment described above. In various embodiments, prior to determining the distance between various embedding vectors, the implementation processing circuitry 106 may be configured to access the score database 118 to identify, from the various embedding vectors stored therein, if any embedding vector is similar to the embedding vector generated for the first object. If no similar embedding vector is identified, the above-mentioned operations may be executed. However, if an embedding vector similar to the embedding vector generated for the first object is identified, the implementation processing circuitry 106 may be further configured to retrieve a relevance score mapped to the identified embedding vector. In such a scenario, the retrieved relevance score may be assigned to the first object and if it is greater than the threshold score, the alert may be generated.

The detection technique of the present disclosure thus incorporates 2D and 3D geometric features, material properties, and contextual data into a single relevance score, providing a holistic assessment not found in simpler, single-modal systems. Further, in the detection technique of the present disclosure various weights are assigned to various real-world factors (e.g., material composition, spatial adjacency, temporal/historical context), ensuring granular control over system sensitivity. The detection technique of the present disclosure also utilizes an exponential decay mechanism to track repeated detections over time, amplifying threat scores when suspicious objects reappear in short intervals. The dynamic adjustment of the threshold score enables the detection technique of the present disclosure to remain effective under varying operational conditions. The integrated synergy of multi-modal feature embedding (e.g., 2D and 3D feature vectors), advanced weighting, dynamic thresholding, and temporal correlation in one unified pipeline, particularly for custom-modified cuts, represents a significant improvement over conventional systems.

The present disclosure thus provides an accurate and robust object detection technique. As the imaging representations used for training the detection network 110 are synthetically generated, the detection network 110 can be trained for different types of restricted items and can be trained for innumerable iterations. In other words, the burden of collecting training data for the network training is significantly reduced. As a result, the detection network 110 is trained more effectively and efficiently as compared to conventional detection systems. Consequently, the detection network 110 is capable of accurately detecting disassembled items. Additionally, the utilization of other real-world factors also strengthens the robustness of the detection technique of the present disclosure. Thus, unlike conventional systems that are limited to recognizing known shapes, the detection technique of the present disclosure enables high-accuracy detection of unknown or custom-shaped objects, even when hidden within multiple layers. By integrating object recognition, material analysis, and multi-layer scanning, the detection technique of the present disclosure offers a more adaptable detection solution, ensuring that restricted items, regardless of their form or concealment, are accurately detected. These advancements enhance overall safety and mitigate security risks in sensitive areas, surpassing the limitations of human-engineered detection with limited datasets.

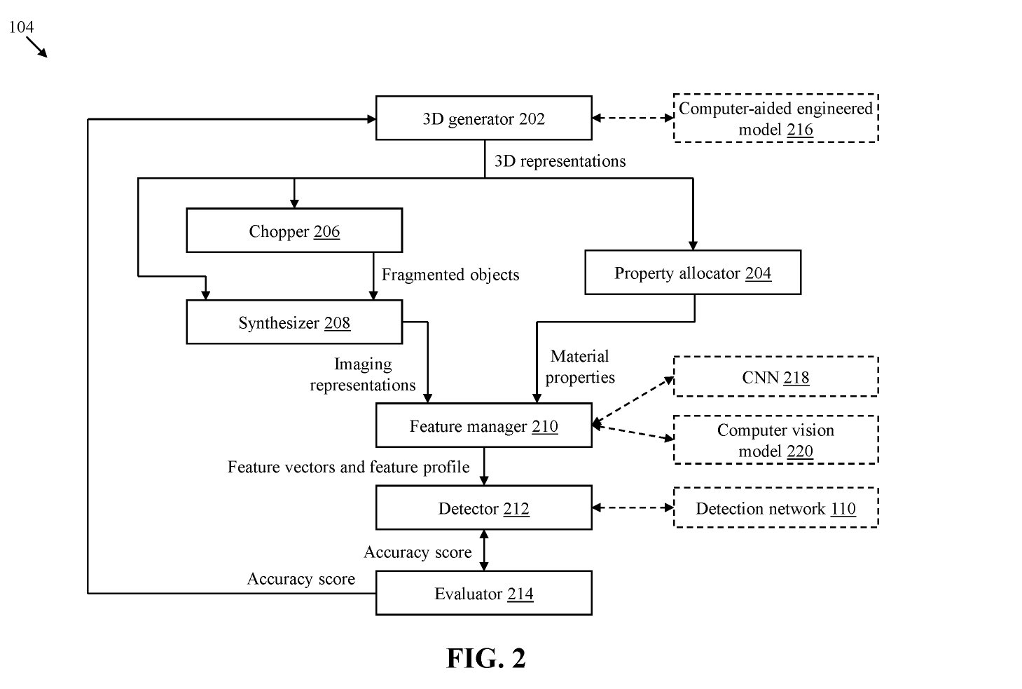

FIG. 2 is a block diagram of the training processing circuitry 104, consistent with disclosed embodiments of the present disclosure. As illustrated in FIG. 2, the training processing circuitry 104 may include a 3D generator 202, a property allocator 204, a chopper 206, a synthesizer 208, a feature manager 210, a detector 212, and an evaluator 214.

The 3D generator 202 may include suitable logic, circuitry, interfaces, and/or code, executable by the circuitry, that may be configured to perform one or more operations. For example, the 3D generator 202 may be configured to generate the plurality of 3D representations for the plurality of items. The 3D generator 202 may generate the 3D representations using a computer-aided engineered model 216. The computer-aided engineered model 216 may be a combination of CAD and CAM models. A CAD model is a digital representation of a physical object, created using specialized software such as AutoCAD, SolidWorks, or Fusion 360. The CAD model provides precise geometrical definitions of parts and assemblies. A CAM model, on the other hand, translates the output of the CAD model into machine-readable instructions for manufacturing.

The property allocator 204 may be coupled to the3D generator 202. The property allocator 204 may include suitable logic, circuitry, interfaces, and/or code, executable by the circuitry, that may be configured to perform one or more operations. For example, the property allocator 204 may be configured to receive the 3D representations from the 3D generator 202. Further, the property allocator 204 may be configured to assign the set of material properties to each 3D representation. In an embodiment, the set of material properties may include a type, a density, a conductivity, a color, an acoustic property, an optical property, a texture, or a combination thereof.

The chopper 206 may be coupled to the3D generator 202. The chopper 206 may include suitable logic, circuitry, interfaces, and/or code, executable by the circuitry, that may be configured to perform one or more operations. For example, the chopper 206 may be configured to receive the 3D representations from the 3D generator 202. Further, the chopper 206 may be configured to fragment each 3D representation into a plurality of objects. To fragment each 3D representation into the plurality of objects, the chopper 206 may be further configured to execute at least one of the set of planar cuts or the set of pattern-based cuts on the corresponding 3D representation. The chopper 206 may fragment each 3D representation into the plurality of objects using the set of constraints. The set of constraints may define various physical considerations with respect to the fragmentation of each object of the plurality of objects.

The synthesizer 208 may be coupled to the 3D generator 202 and the chopper 206. The synthesizer 208 may include suitable logic, circuitry, interfaces, and/or code, executable by the circuitry, that may be configured to perform one or more operations. For example, the synthesizer 208 may be configured to receive the 3D representations and the fragmented objects from the 3D generator 202 and the chopper 206, respectively. The synthesizer 208 may be further configured to synthesize a set of imaging representations for each of the plurality of 3D representations and for each object fragmented from each 3D representation.

The feature manager 210 may be coupled to the property allocator 204 and the synthesizer 208. The feature manager 210 may include suitable logic, circuitry, interfaces, and/or code, executable by the circuitry, that may be configured to perform one or more operations. For example, the feature manager 210 may be configured to receive the material properties assigned to each 3D representation and the synthesized imaging representations from the property allocator 204 and the synthesizer 208, respectively.

The feature manager 210 may be further configured to augment each imaging representation with metadata. For an imaging representation of a 3D representation (e.g., an item), the metadata may indicate the material properties of the associated 3D representation. On the other hand, for an imaging representation of an object (e.g., a disassembled piece), the metadata may indicate the material properties of the object associated with the corresponding imaging representation, a link between the associated object and the 3D representation from which the associated object is fragmented, and a cutting technique via which the associated object is fragmented.

The feature manager 210 may be further configured to generate the first feature vector for each augmented imaging representation using a CNN 218. The CNN 218 is a deep learning architecture specifically designed for processing grid-like data, such as images. The CNN 218 may include multiple layers, including convolutional layers, pooling layers, and fully connected layers. The convolutional layers apply learnable filters (e.g., kernels) that detect spatial features like edges, textures, and complex patterns by performing element-wise multiplications and summing the results. These feature maps are then passed through activation functions to introduce non-linearity. Pooling layers downsample the feature maps, reducing computational complexity while preserving essential spatial information. The extracted features are ultimately passed through one or more fully connected layers, where the CNN 218 learns high-level representations and makes predictions.

The feature manager 210 may be further configured to generate the second feature vector that represents one or more geometric properties captured from each augmented imaging representation. In an embodiment, the one or more geometric properties may include surface shape, volume distribution, internal structure, or the like. The one or more geometric properties may be captured using a computer vision model 220. The computer vision model 220 is a machine learning or deep learning system designed to interpret and analyze visual data, such as images and videos. The computer vision model 220 may typically rely on CNNs, vision transformers, or hybrid architectures to extract meaningful features from raw pixel data. The model processes input images through multiple layers, including convolutional layers for feature extraction, pooling layers for dimensionality reduction, and fully connected layers for decision-making. The computer vision model 220 may also use object detection techniques to identify and locate multiple objects within an image.

The feature manager 210 may be further configured to generate the feature profile for each augmented imaging representation based on the metadata associated with the corresponding augmented imaging representation. The feature profile may indicate the set of material properties of the object and the linking of the object to the original item.

The detector 212 may be coupled to the feature manager 210 and the storage element 108. The detector 212 may include suitable logic, circuitry, interfaces, and/or code, executable by the circuitry, that may be configured to perform one or more operations. For example, the detector 212 may be configured to receive the first and second feature vectors and the feature profile from the feature manager 210.

Based on the first feature vector, the second feature vector, and the feature profile generated for an augmented imaging representation, the detector 212 may be further configured to train the detection network 110. The detection network 110 is trained such that post the training, the detection network 110 may be utilized to generate, in the feature space, the first embedding vector for the first test imaging representation of the first test object.

The detector 212 may train the detection network 110 using various training batches. Each training batch may include augmented imaging representations of objects fragmented from different 3D representations as well as one of the original 3D representations. Such construction of training batches ensures that the detection network 110 is trained robustly with an anchor item (e.g., a known item), positive examples (e.g., fragmented pieces from the same item), and negative examples (e.g., parts from different items). The detector 212 may thus use a similarity or embedding approach, instead of a straightforward classifier, to learn a feature space where components belonging to the same original assembly are clustered together even if they have been custom-fragmented. The detection network 110 may typically use contrastive or triplet loss which ensures objects from the same item are closer in the feature space, while objects from different items are pushed further apart. The detector 212 may be further configured to store the detection network 110 in the storage element 108.

The evaluator 214 may be coupled to the detector 212 and the 3D generator 202. The evaluator 214 may include suitable logic, circuitry, interfaces, and/or code, executable by the circuitry, that may be configured to perform one or more operations. For example, the evaluator 214 may be configured to evaluate the trained detection network 110. The trained detection network 110 may be evaluated using objects that are not part of the training dataset. To evaluate the trained detection network 110, the evaluator 214 may execute various operations. For example, the evaluator 214 may be further configured to compare distances between the first embedding vector generated by the trained detection network 110 and the embedding vectors of objects associated with the first test object and distances between the first embedding vector and the embedding vectors of objects not associated with the first test object. Based on the comparison, the evaluator 214 may be further configured to assign the accuracy score to the detection network 110. The accuracy score may be high if embedding vectors of same items are close to each other and embedding vectors of different items are spaced apart. The aforementioned operations may be executed for varying material properties or morphological details. The training of the detection network 110 is completed based on the accuracy score being greater than the accuracy threshold.

If the accuracy score of the detection network 110 is less than the accuracy threshold, the detector 212 may be further configured to calibrate the one or more hyperparameters associated with the detection network 110. Additionally, if the accuracy score of the detection network 110 is less than the accuracy threshold, the detection network 110 may be iteratively trained using new 3D representations until the accuracy score is greater than the accuracy threshold.

As the training dataset is synthesized, the training of the detection network 110 can be tailored to the detection of specific items or disassembly. For example, if the detection network 110 has lower accuracy in detecting a specific item or disassembly, the 3D generator 202 may be further configured to generate a new 3D representation for the specific item or disassembly, with the detection network 110 being trained further based on the new 3D representation in the similar manner described above. The synthesized training dataset also allows the training of the detection network 110 for new items. For example, based on the evaluation of the detection network 110, the 3D generator 202 may be further configured to generate a new 3D representation for a new item, with the detection network 110 being trained further based on the new 3D representation in the similar manner described above.

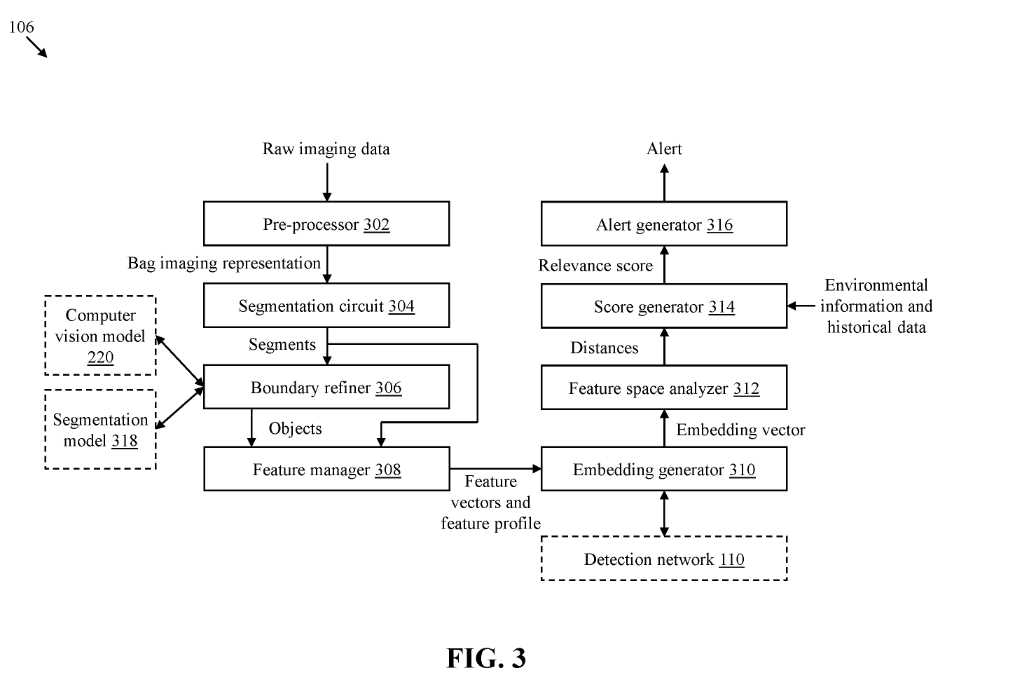

FIG. 3 is a block diagram of the implementation processing circuitry 106, consistent with disclosed embodiments of the present disclosure. As illustrated in FIG. 3, the implementation processing circuitry 106 may include a pre-processor 302, a segmentation circuit 304, a boundary refiner 306, a feature manager 308, an embedding generator 310, a feature space analyzer 312, a score generator 314, and an alert generator 316.

The trained detection network 110 can be implemented inside the facility 102 for detecting various disassembled items. The facility 102 may include the scanner 114. The scanner 114 may be configured to scan the bag 116 carried by the user, and generate the raw imaging data.

The pre-processor 302 may be coupled to the scanner 114. The pre-processor 302 may include suitable logic, circuitry, interfaces, and/or code, executable by the circuitry, that may be configured to perform one or more operations. For example, the pre-processor 302 may be configured to receive the raw imaging data from the scanner 114. The pre-processor 302 may be further configured to execute the one or more pre-processing operations on the raw imaging data to obtain the bag imaging representation of the bag 116.

The segmentation circuit 304 may be coupled to the pre-processor 302. The segmentation circuit 304 may include suitable logic, circuitry, interfaces, and/or code, executable by the circuitry, that may be configured to perform one or more operations. For example, the segmentation circuit 304 may be configured to receive the bag imaging representation from the pre-processor 302. The segmentation circuit 304 may be further configured to identify, in the bag imaging representation, the first segment representing the first material. In an embodiment, the segmentation circuit 304 may be further configured to generate the energy attenuation profile for the bag imaging representation, and the first segment is identified in the bag imaging representation based on the energy attenuation profile. In another embodiment, the segmentation circuit 304 may be further configured to generate at least one of the voxel density profile or the morphological profile for the bag imaging representation, and the first segment is identified in the bag imaging representation based on at least one of the voxel density profile or the morphological profile.

The boundary refiner 306 may be coupled to the segmentation circuit 304 and the storage element 108. The boundary refiner 306 may include suitable logic, circuitry, interfaces, and/or code, executable by the circuitry, that may be configured to perform one or more operations. For example, the boundary refiner 306 may be configured to receive various segments (e.g., the first segment) from the segmentation circuit 304. The boundary refiner 306 may be further configured to refine the boundary of the first segment such that the first segment with the refined boundary represents the first object. The boundary refiner 306 may refine the boundary of the first segment using the computer vision model 220 or a segmentation model 318.

The segmentation model 318 may be designed to assign a semantic label to each pixel in an image, enabling detailed delineation of object boundaries and comprehensive scene understanding. The segmentation model 318 often adopts an encoder-decoder architecture where the encoder, typically a series of convolutional layers, extracts hierarchical features from the input image, while the decoder gradually restores spatial resolution through up-sampling or transposed convolutions. To enhance accuracy, skip connections are frequently integrated, merging high-resolution spatial details from early layers with deeper, context-rich features from later layers.

The feature manager 308 may be coupled to the boundary refiner 306 and the segmentation circuit 304. The feature manager 308 may include suitable logic, circuitry, interfaces, and/or code, executable by the circuitry, that may be configured to perform one or more operations. For example, the feature manager 308 may be configured to receive segments (e.g., the first segment) from the segmentation circuit 304, and various objects (e.g., the first object) from the boundary refiner 306.

The feature manager 308 may be further configured to generate the feature profile for the first object based on the first material and the refined boundary of the first segment. The feature profile may be generated further based on the volumetric information associated with the first object, the texture pattern associated with the first object, the density gradient information associated with the first object, the spatial relationship between the first object and one or more other objects in the bag imaging representation, or a combination thereof. The feature manager 308 may be further configured to generate the first feature vector and the second feature vector for the first object in a similar manner as described for the feature manager 210.

The embedding generator 310 may be coupled to the feature manager 308. The embedding generator 310 may include suitable logic, circuitry, interfaces, and/or code, executable by the circuitry, that may be configured to perform one or more operations. For example, the embedding generator 310 may be configured to receive the first and second feature vectors and the feature profile from the feature manager 308. The embedding generator 310 may be further configured to generate, using the detection network 110, in the feature space, the embedding vector for the first object based on the feature profile, the first feature vector, and the second feature vector.

The feature space analyzer 312 may be coupled to the embedding generator 310. The feature space analyzer 312 may include suitable logic, circuitry, interfaces, and/or code, executable by the circuitry, that may be configured to perform one or more operations. The feature space may also include various other embedding vectors representing various other objects. In the feature space, the feature space analyzer 312 may be further configured to determine distances between the embedding vector generated for the first object and the other embedding vectors. Each distance is indicative of a degree of association of the first object with a corresponding object.

The score generator 314 may be coupled to the feature space analyzer 312 and the facility controller 122. The score generator 314 may include suitable logic, circuitry, interfaces, and/or code, executable by the circuitry, that may be configured to perform one or more operations. For example, the score generator 314 may be configured to receive the determined distances from the feature space analyzer 312. Further, the score generator 314 may be configured to receive the environmental information indicative of the physical environment associated with the first object and the historical data associated with the physical environment from the facility controller 122.

The score generator 314 may be further configured to compare the distances with the association threshold. Based on the comparison, the score generator 314 may be further configured to assign the relevance score to the first object. In one example, each of the plurality of distances may be greater than the association threshold. Based on each of the plurality of distances being greater than the association threshold, the relevance score assigned to the first object may be less than the threshold score. In another example, some distances may be less than the association threshold. In such a scenario, the score generator 314 may be further configured to identify a set of distances that is less than the association threshold. The set of distances may be between the embedding vector generated for the first object and a set of embedding vectors generated for a set of objects. Based on the set of distances being less than the association threshold, the score generator 314 may be further configured to determine that the first object is associated with the set of objects. Based on the first object being associated with the set of objects, the relevance score assigned to the first object is greater than the threshold score.

In an embodiment, the score generator 314 may assign the relevance score to the first object further based on the temporal information associated with detection of the set of objects. The temporal information associated with detection of the set of objects indicates whether similar or associated components are detected in close temporal proximity. In another embodiment, the type of the first material, the environmental information, and the historical data may be utilized for assigning the relevance score to the first object. For example, the score generator 314 may be further configured to assign a weight to each of the type of the first material, the environmental information, and the historical data. The weight assigned to each of the type of the first material, the environmental information, and the historical data may be dynamic. The relevance score is assigned to the first object further based on the type of the first material, the weight assigned to the type of the first material, the environmental information, the weight assigned to the environmental information, the historical data, and the weight assigned to the historical data.

Although not shown, the score generator 314 may be further configured to generate a mapping between the first object, the embedding vector generated for the first object, and the relevance score assigned to the first object, and store the mapping in the storage element 108 (e.g., the score database 118).

The alert generator 316 may be coupled to the score generator 314. The alert generator 316 may include suitable logic, circuitry, interfaces, and/or code, executable by the circuitry, that may be configured to perform one or more operations. For example, the alert generator 316 may be configured to receive the relevance score from the score generator 314.

The alert generator 316 may be further configured to compare the assigned relevance score with the threshold score. The threshold score may be set based on historical performance and known risk levels. Further, historical adjustments may update the threshold score over time using system logs and false alarm rates. In an embodiment, the threshold score may be a function of the one or more historical outputs generated using the detection network 110. In other words, the threshold score is adjusted based on past detection patterns. In another embodiment, the threshold score may be a function of the environmental information. In yet another embodiment, the threshold score may be a function of one or more current real-world events.

The comparison of the assigned relevance score with the threshold score indicates whether the first object is part of a restricted item. The relevance score being less than the threshold score indicates that the first object is not part of the restricted item. In such a scenario, no further action may be taken. The relevance score being greater than the threshold score indicates that the first object and the set of objects are part of the restricted item.

The alert generator 316 may be further configured to generate the alert based on the relevance score being greater than the threshold score. The alert generator 316 may be further configured to present the alert on the user device 120.

Other segments present in the bag imaging representation may be detected in a similar manner as described above. Further, although not shown, the facility 102 may include various other scanners, apart from the scanner 114, and the imaging data from each such scanner may be processed in a similar manner as described above to detect disassembled items. The trained detection network 110 may thus be utilized to detect disassembled items in the facility 102.

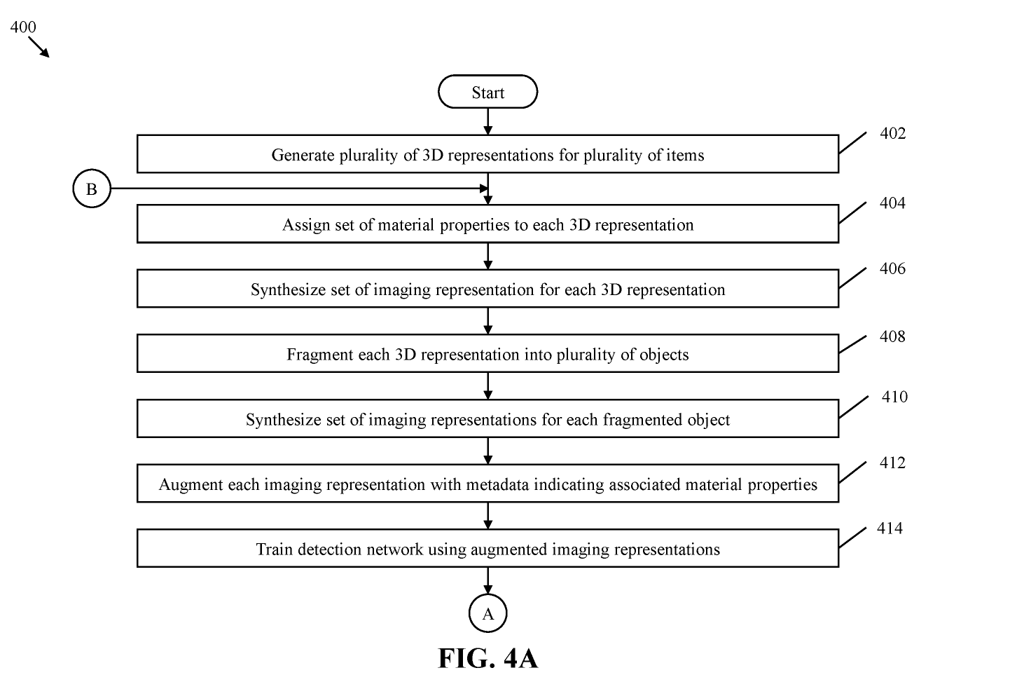

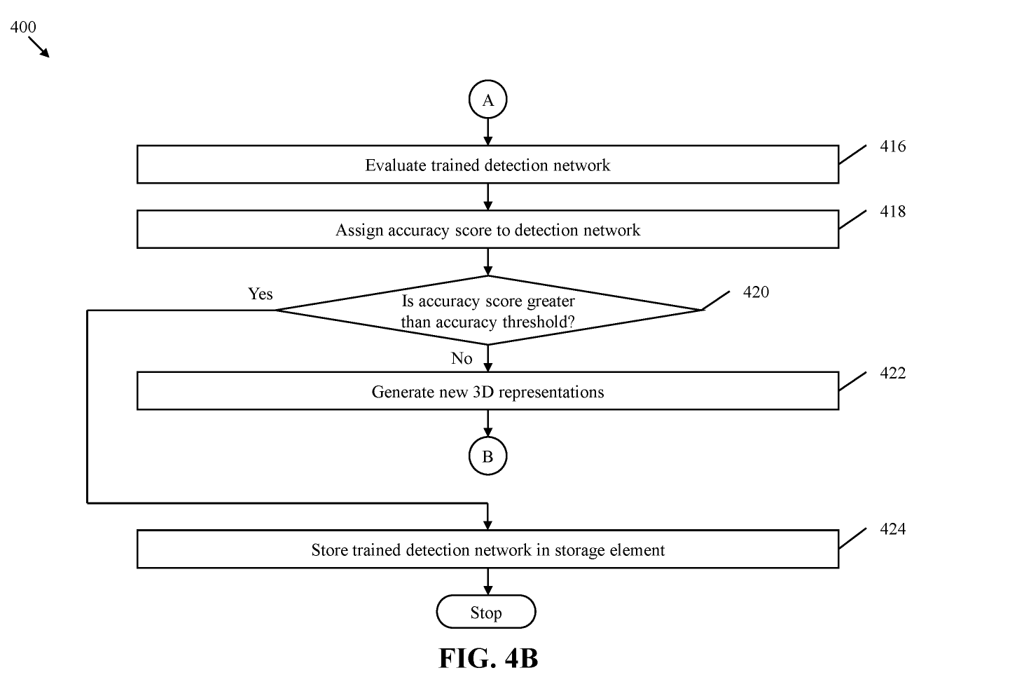

FIGS. 4A and 4B, collectively, represents a flowchart 400 that illustrates a method for training the detection network 110, consistent with disclosed embodiments of the present disclosure. The detection network 110 may be trained to generate an embedding vector in a feature space for each imaging representation of an object.

Referring to FIG. 4A, at 402, the training processing circuitry 104 may generate a plurality of 3D representations for a plurality of items. The training processing circuitry 104 may generate the 3D representations using the computer-aided engineered model 216. At 404, the training processing circuitry 104 may assign a set of material properties to each 3D representation. In an embodiment, the set of material properties may include a type, a density, a conductivity, a color, an acoustic property, an optical property, a texture, or a combination thereof. At 406, the training processing circuitry 104 may synthesize a set of imaging representations for each 3D representation.

At 408, the training processing circuitry 104 may fragment each 3D representation into a plurality of objects. The training processing circuitry 104 may fragment each 3D representation using a set of constraints. At 410, the training processing circuitry 104 may synthesize a set of imaging representations for each fragmented object. At 412, the training processing circuitry 104 may augment each imaging representation with metadata indicating associated material properties. At 414, the training processing circuitry 104 may train the detection network 110 using the augmented imaging representations. The detection network 110 may be trained based on the first feature vector, the second feature vector, and the feature profile generated for each augmented imaging representation. The detection network 110 is trained such that post the training, the detection network 110 may be utilized to generate, in the feature space, a first embedding vector for a first test imaging representation of a first test object.

Referring to FIG. 4B, at 416, the training processing circuitry 104 may evaluate the trained detection network 110. The trained detection network 110 may be evaluated using objects that are not part of the training dataset. At 418, the training processing circuitry 104 may assign an accuracy score to the detection network 110. The accuracy score may be assigned based on the evaluation of the detection network 110.

At 420, the training processing circuitry 104 may determine whether the accuracy score is greater than the accuracy threshold. If at 420, it is determined that the accuracy score is not greater than the accuracy threshold, 422 is performed. At 422, the training processing circuitry 104 may generate new 3D representations. The detection network 110 may then be adaptively trained using the new 3D representations. However, if at 420, it is determined that the accuracy score is greater than the accuracy threshold, 424 is performed. At 424, the training processing circuitry 104 may store the trained detection network 110 in the storage element 108.

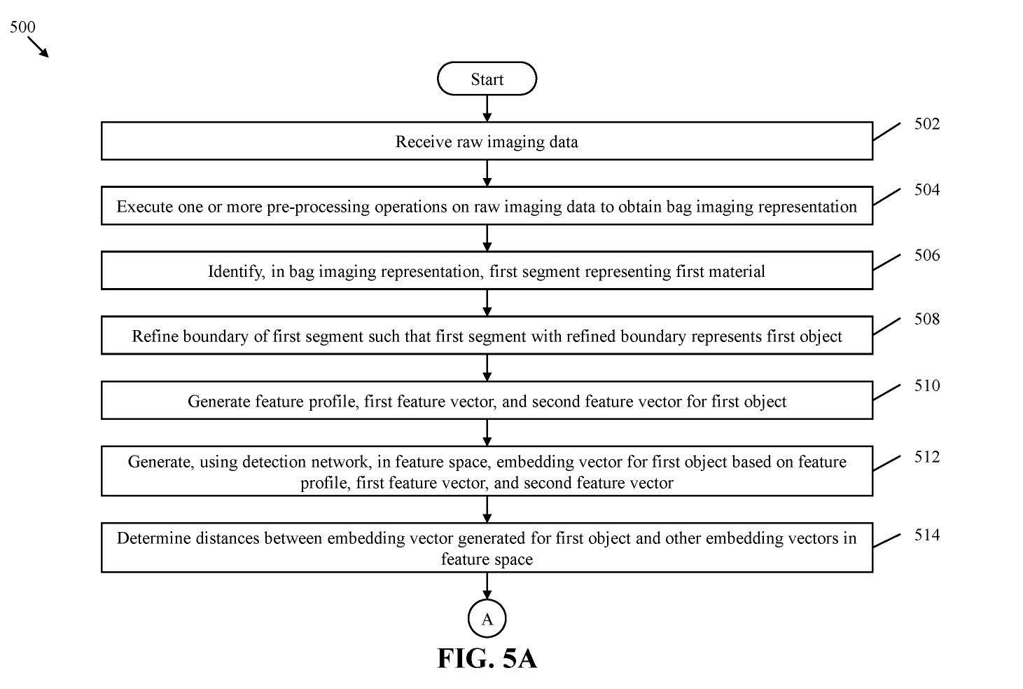

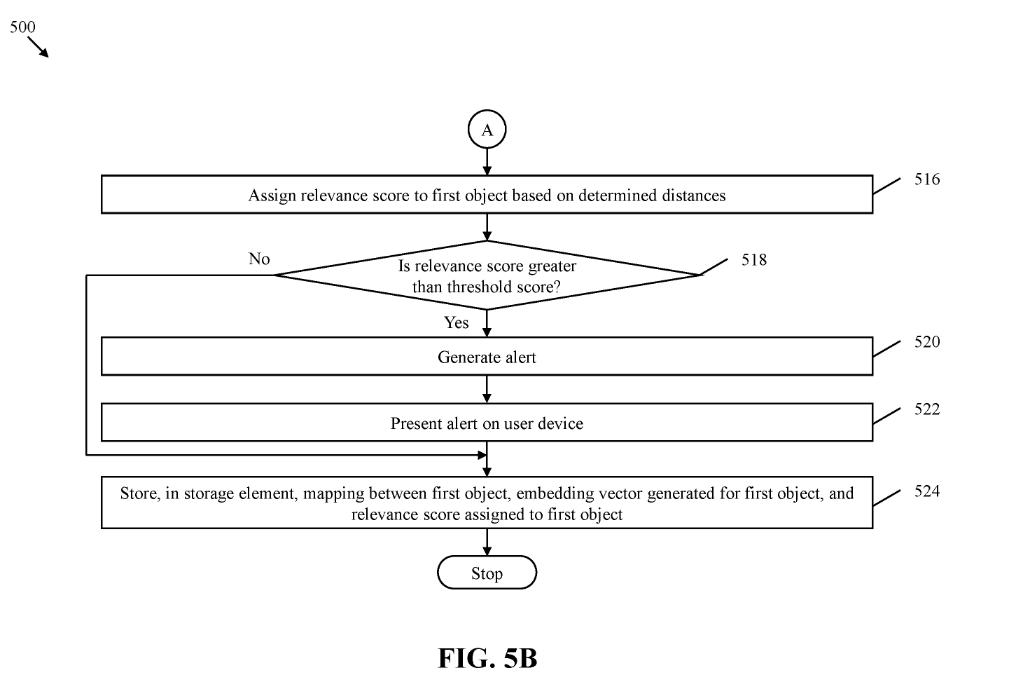

FIGS. 5A and 5B, collectively, represents a flowchart 500 that illustrates a method for detecting disassembled items using the trained detection network 110, consistent with disclosed embodiments of the present disclosure. The trained detection network 110 can be implemented for detecting various disassembled items inside the facility 102.

Referring to FIG. 5A, at 502, the implementation processing circuitry 106 may receive the raw imaging data. The raw imaging data may be generated by the scanner 114 when the bag 116 is passed through the scanner 114. The raw imaging data may include 2D X-ray images (e.g., multi-energy or dual-energy X-ray images) and/or 3D CT volumetric data.

At 504, the implementation processing circuitry 106 may execute one or more pre-processing operations on the raw imaging data to obtain the bag imaging representation. The one or more pre-processing operations correspond to at least one of a noise reduction operation, an image filtering operation, a calibration operation, or a normalization operation. The bag imaging representation may include a 2D imaging representation, a 3D imaging representation, or a combination thereof.

At 506, the implementation processing circuitry 106 may identify, in the bag imaging representation, the first segment representing the first material. At 508, the implementation processing circuitry 106 may refine the boundary of the first segment such that the first segment with the refined boundary represents the first object. The implementation processing circuitry 106 may refine the boundary of the first segment using the computer vision model 220 or the segmentation model 318.

At 510, the implementation processing circuitry 106 may generate the feature profile, the first feature vector, and the second feature vector for the first object. The feature profile for the first object may be generated based on the first material and the refined boundary of the first segment. The feature profile may be generated further based on the volumetric information associated with the first object, the texture pattern associated with the first object, the density gradient information associated with the first object, and the spatial relationship between the first object and one or more other objects in the bag imaging representation. The first feature vector may be generated for the first segment using the CNN 218. Further, the second feature vector represents one or more geometric properties captured from the first segment.

At 512, the implementation processing circuitry 106 may generate, using the detection network 110, in the feature space, the embedding vector for the first object based on the feature profile, the first feature vector, and the second feature vector. The feature space may also include other embedding vectors representing other objects. At 514, the implementation processing circuitry 106 may determine the distances between the embedding vector generated for the first object and other embedding vectors in the feature space. Each distance is indicative of a degree of association of the first object with a corresponding object.

Referring to FIG. 5B, at 516, the implementation processing circuitry 106 may assign the relevance score to the first object based on the determined distances. At 518, the implementation processing circuitry 106 may determine whether the relevance score is greater than the threshold score. If at 518, it is determined that the relevance score is greater than the threshold score, 520 is performed. At 520, the implementation processing circuitry 106 may generate the alert. The alert may indicate that the first object may be part of a restricted item. At 522, the implementation processing circuitry 106 may present the alert on the user device 120. At 524, the implementation processing circuitry 106 may store, in the storage element 108, the mapping between the first object, the embedding vector generated for the first object, and the relevance score assigned to the first object. If at 518, it is determined that the relevance score is not greater than the threshold score, 524 is performed. No further action may be taken in such a scenario as the first object may be considered to not be part of any restricted items.

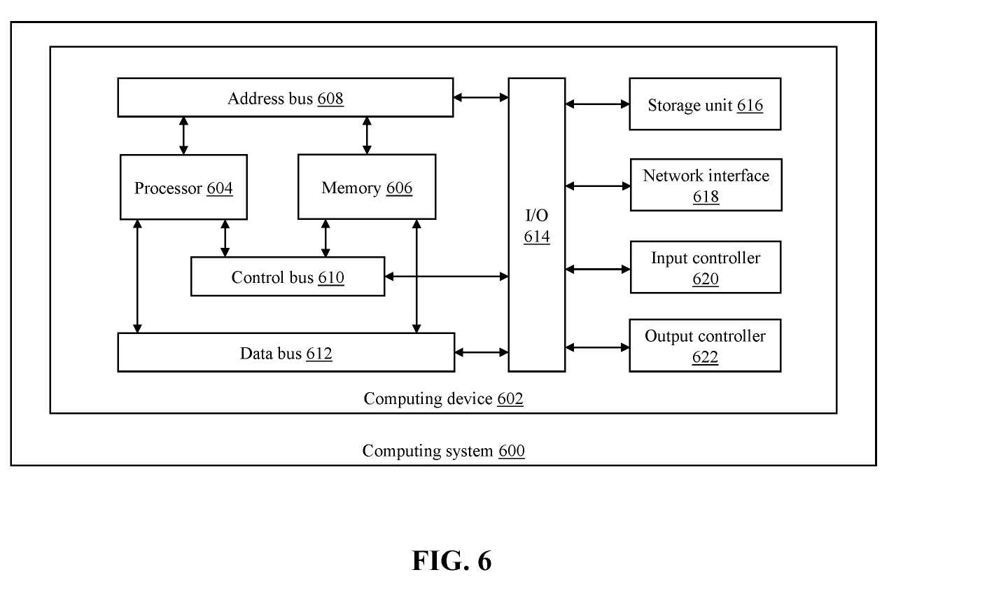

FIG. 6 shows an example computing system 600 for carrying out the methods of the present disclosure, consistent with disclosed embodiments of the present disclosure. Specifically, FIG. 6 shows a block diagram of an embodiment of the computing system 600 according to example embodiments of the present disclosure.

The computing system 600 may be configured to perform any of the operations disclosed herein. The computing system 600 may be implemented as a conventional computer system, an embedded controller, a laptop, a server, a mobile device, a smartphone, a customized machine, any other hardware platform, or any combination or multiplicity thereof. In one embodiment, the computing system 600 is a distributed system configured to function using multiple computing machines interconnected via a data network or bus system.

The computing system 600 includes computing devices (such as a computing device 602). The computing device 602 includes one or more processors (such as a processor 604) and a memory 606. The processor 604 may be any general-purpose processor(s) configured to execute a set of instructions. For example, the processor 604 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 604 may be multiple processing units, a single processing core, multiple processing cores, special purpose processing cores, co-processors, or any combination thereof. The processor 604 may be communicatively coupled to the memory 606 via an address bus 608, a control bus 610, and a data bus 612.

The memory 606 may include non-volatile memories such as a read-only memory (ROM), a programable read-only memory (PROM), an erasable programmable read-only memory (EPROM), a flash memory, or any other device capable of storing program instructions or data with or without applied power. The memory 606 may also include volatile memories, such as a random-access-memory (RAM), a static random-access-memory (SRAM), a dynamic random-access-memory (DRAM), and a synchronous dynamic random-access-memory (SDRAM). The memory 606 may include single or multiple memory modules. While the memory 606 is depicted as part of the computing device 602, a person skilled in the art will recognize that the memory 606 may be separate from the computing device 602.

The memory 606 may store information that may be accessed by the processor 604. For instance, the memory 606 (e.g., one or more non-transitory computer-readable storage mediums, memory devices) may include computer-readable instructions (not shown) that may be executed by the processor 604. The computer-readable instructions may be software written in any suitable programming language or may be implemented in hardware. Additionally, or alternatively, the computer-readable instructions may be executed in logically and/or virtually separate threads on the processor 604. For example, the memory 606 may store instructions (not shown) that when executed by the processor 604 cause the processor 604 to perform operations such as any of the operations and functions for which the computing system 600 is configured, as described herein. Additionally, or alternatively, the memory 606 may store data (not shown) that may be obtained, received, accessed, written, manipulated, created, and/or stored. The data may include, for instance, the data and/or information described herein in relation to FIGS. 1-5. In some implementations, the computing device 602 may obtain from and/or store data in one or more memory device(s) that are remote from the computing system 600.

The computing device 602 may further include an input/output (I/O) interface 614 communicatively coupled to the address bus 608, the control bus 610, and the data bus 612. The data bus 612 may include a plurality of tunnels that may support communication in the object detection environment 100. The I/O interface 614 is configured to couple to one or more external devices (e.g., to receive and send data from/to one or more external devices). Such external devices, along with the various internal devices, may also be known as peripheral devices. The I/O interface 614 may include both electrical and physical connections for operably coupling the various peripheral devices to the computing device 602. The I/O interface 614 may be configured to communicate data, addresses, and control signals between the peripheral devices and the computing device 602. The I/O interface 614 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, and the like. The I/O interface 614 is configured to implement only one interface or bus technology. Alternatively, the I/O interface 614 is configured to implement multiple interfaces or bus technologies. The I/O interface 614 may include one or more buffers for buffering transmissions between one or more external devices, internal devices, the computing device 602, or the processor 604. The I/O interface 614 may couple the computing device 602 to various input devices, including touch screens, scanners, biometric readers, electronic digitizers, receivers, touchpads, cameras, keyboards, any other pointing devices, or any combinations thereof. The I/O interface 614 may couple the computing device 602 to various output devices, including printers, projectors, tactile feedback devices, automation control, robotic components, actuators, transmitters, signal emitters, lights, and so forth.

The computing system 600 may further include a storage unit 616, a network interface 618, an input controller 620, and an output controller 622. The storage unit 616, the network interface 618, the input controller 620, and the output controller 622 are communicatively coupled to the central control unit (e.g., the memory 606, the address bus 608, the control bus 610, and the data bus 612) via the I/O interface 614. The network interface 618 communicatively couples the computing system 600 to one or more networks such as wide area networks (WAN), local area networks (LAN), intranets, the Internet, wireless access networks, wired networks, mobile networks, telephone networks, optical networks, or combinations thereof. The network interface 618 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 616 is a computer-readable medium, preferably a non-transitory computer-readable medium, comprising one or more programs, the one or more programs comprising instructions which when executed by the processor 604 cause the computing system 600 to perform the method steps of the present disclosure. Alternatively, the storage unit 616 is a transitory computer-readable medium. The storage unit 616 may include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 616 stores one or more operating systems, application programs, program modules, data, or any other information. The storage unit 616 is part of the computing device 602. Alternatively, the storage unit 616 is part of one or more other computing machines that are in communication with the computing device 602, such as servers, database servers, cloud storage, network attached storage, and so forth.

The input controller 620 may include suitable logic, circuitry, interfaces, and/or code, executable by the circuitry, that may be configured to control one or more input devices that may be configured to receive imaging data. The output controller 622 may include suitable logic, circuitry, interfaces, and/or code, executable by the circuitry, that may be configured to control one or more output devices that may be configured to output relevance scores and alerts.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for detection of disassembled items. While various embodiments of the disclosed systems and methods have been described above, they have been presented for purposes of example only, and not limitations. It is not exhaustive and does not limit the present disclosure to the precise form disclosed. Modifications and variations are possible considering the above teachings or may be acquired from practicing the present disclosure, without departing from the breadth or scope.

What is claimed is:

1. A system, comprising:
processing circuitry that is configured to:
generate a plurality of three-dimensional (3D) representations for a plurality of items;
assign a set of material properties to each of the plurality of 3D representations;
fragment each 3D representation, of the plurality of 3D representations, into a plurality of objects;
synthesize a plurality of imaging representations, with a set of imaging representations being synthesized for each object fragmented from the plurality of 3D representations;
augment each imaging representation, of the plurality of imaging representations, with metadata indicating the set of material properties of an object of the plurality of objects associated with the corresponding imaging representation, thereby generating a plurality of augmented imaging representations; and
train, using the plurality of augmented imaging representations, a detection network to generate, in a feature space, a first embedding vector for a first test imaging representation of a first test object, wherein, in the feature space, a distance between the first embedding vector and a second embedding vector generated for a second test object indicates a degree of association of the first test object with the second test object.

2. The system of claim 1, wherein the processing circuitry is further configured to execute at least one of a set of planar cuts or a set of pattern-based cuts on each 3D representation of the plurality of 3D representations to fragment the corresponding 3D representation into the plurality of objects.

3. The system of claim 1,
wherein the processing circuitry is configured to fragment each 3D representation, of the plurality of 3D representations, into the plurality of objects using a set of constraints, and
wherein the set of constraints comprises at least one of:
a volume of each object of the plurality of objects being greater than a volume tolerance value,
a thickness of each object of the plurality of objects being greater than a thickness tolerance value, or
a count of the plurality of objects being less than a threshold.

4. The system of claim 1,
wherein each 3D representation of the plurality of 3D representations has a first identifier associated therewith,
wherein each object of the plurality of objects has a second identifier associated therewith, and
wherein the metadata augmented to each imaging representation, of the plurality of imaging representations, further indicates a link between the second identifier of the associated object and the first identifier of the 3D representation from which the associated object is fragmented.

5. The system of claim 1, wherein the metadata augmented to each imaging representation, of the plurality of imaging representations, further indicates a cutting technique via which the associated object is fragmented.

6. The system of claim 1, wherein an imaging representation, of the plurality of imaging representations, comprises at least one of a two-dimensional (2D) imaging representation and a 3D imaging representation.

7. The system of claim 1, wherein based on the plurality of augmented imaging representations, the processing circuitry is further configured to:
generate a first feature vector for each augmented imaging representation using a convolutional neural network;
generate a second feature vector that represents one or more geometric properties captured from each augmented imaging representation using a computer vision model; and
generate a feature profile for each augmented imaging representation based on the metadata associated with the corresponding augmented imaging representation, wherein the detection network is trained based on the first feature vector, the second feature vector, and the feature profile.

8. The system of claim 1,
wherein the processing circuitry is configured to train the detection network using a plurality of training batches, with each training batch comprising a set of augmented imaging representations of a set of objects, and
wherein the set of objects comprises (i) at least one object fragmented from one 3D representation of the plurality of 3D representations, and (ii) another object fragmented from a different 3D representation of the plurality of 3D representations.

9. The system of claim 1, wherein the processing circuitry is further configured to:
synthesize an imaging representation for each of the plurality of 3D representations; and
augment the imaging representation with another metadata indicating the set of material properties of the associated 3D representation, wherein the detection network is trained further based on the augmented imaging representation associated with each of the plurality of 3D representations.

10. The system of claim 9,
wherein the processing circuitry is configured to train the detection network using a plurality of training batches, with each training batch comprising a set of augmented imaging representations of a set of objects,
wherein the set of objects comprises (i) at least one object fragmented from a first 3D representation of the plurality of 3D representations, and (ii) another object fragmented from a second 3D representation of the plurality of 3D representations, and
wherein each training batch, of the plurality of training batches further comprises the augmented imaging representation associated with one of the first 3D representation or the second 3D representation.

11. The system of claim 1,
wherein when the distance between the first embedding vector and the second embedding vector is greater than an association threshold, the first test object and the second test object are not part of a same item, and
wherein when the distance between the first embedding vector and the second embedding vector is less than the association threshold, the first test object and the second test object are part of the same item.

12. The system of claim 1, wherein the processing circuitry is further configured to evaluate the trained detection network.

13. The system of claim 12, wherein to evaluate the trained detection network, the processing circuitry is further configured to:
determine a first distance between the first embedding vector generated by the trained detection network and a third embedding vector associated with a first reference object, wherein the first test object and the first reference object are part of one item of the plurality of items;
determine a second distance between the first embedding vector generated by the trained detection network and a fourth embedding vector associated with a second reference object, wherein the first test object and the second reference object are part of different items of the plurality of items; and
compare the first distance and the second distance.

14. The system of claim 12, wherein the processing circuitry is further configured to calibrate one or more hyperparameters associated with the detection network based on the evaluation of the detection network.

15. The system of claim 14, wherein the one or more hyperparameters include at least one of a margin for a triplet loss, a learning rate of the detection network, or a number of embedding dimensions.

16. The system of claim 12, wherein based on the evaluation of the detection network, the processing circuitry is further configured to generate a new 3D representation, wherein the new 3D representation is generated for one of the plurality of items or a new item, and wherein the detection network is trained further based on the new 3D representation.

17. The system of claim 16, wherein prior to the training of the detection network, the processing circuitry is further configured to fragment the new 3D representation into another plurality of objects, and wherein at least one object fragmented from the new 3D representation is same as at least one object fragmented from one of the plurality of 3D representations.

18. The system of claim 16, wherein prior to the training of the detection network, the processing circuitry is further configured to fragment the new 3D representation into another plurality of objects, and wherein at least one object fragmented from the new 3D representation is different from the plurality of objects fragmented from each of the plurality of 3D representations.

19. The system of claim 1, further comprises a storage element that is coupled to the processing circuitry, wherein the processing circuitry is further configured to store the trained detection network in the storage element.

20. A method, comprising:
generating, by processing circuitry, a plurality of three-dimensional (3D) representations for a plurality of items;
assigning, by the processing circuitry, a set of material properties to each of the plurality of 3D representations;
fragmenting, by the processing circuitry, each 3D representation, of the plurality of 3D representations, into a plurality of objects;
synthesizing, by the processing circuitry, a plurality of imaging representations, with a set of imaging representations being synthesized for each object fragmented from the plurality of 3D representations;
augmenting, by the processing circuitry, each imaging representation, of the plurality of imaging representations, with metadata indicating the set of material properties of an object of the plurality of objects associated with the corresponding imaging representation, thereby generating a plurality of augmented imaging representations; and
training, by the processing circuitry, using the plurality of augmented imaging representations, a detection network to generate, in a feature space, a first embedding vector for a first test imaging representation of a first test object, wherein, in the feature space, a distance between the first embedding vector and a second embedding vector generated for a second test object indicates a degree of association of the first test object with the second test object.
